(19) United States
(12) Patent Application Publication
(10) Pub. No.: US 2014/0208705 A1
(43) Pub. Date: Jul. 31, 2014

(54) Mutli-Pass Fluted Filter

(71) Applicant: Timothy L. Krull, Kearney, NE (US)

(72) Inventor: Timothy L. Krull, Kearney, NE (US)

(73) Assignee: BALDWIN FILTERS, INC., Kearney, NE (US)

(21) Appl. No.: 14/159,080

(22) Filed: Jan. 20, 2014

Related U.S. Application Data
(60) Provisional application No. 61/756,879, filed on Jan. 25, 2013.

(51) Int. Cl. B01D 46/52; B01D 29/03

(52) U.S. Cl. CPC B01D 46/526; B01D 29/031
USPC 55/487; 210/492; 55/497; 156/196; 156/60

(57) ABSTRACT

Filter media, filter elements, and method of forming filter media and filter elements are provided. The filter media and filter elements require filtered fluid to pass through filter media twice. The filter media and filter elements generally relate to fluted or similar style filter media. The filter media is formed from convoluted sheets coupled to face sheets to form first and second sets of flutes. At least one of the flute sets includes inlet and outlet seals and the other one of the flutes includes an intermediate seal interposed between the inlet and outlet seals of the other flute set. This forces the fluid to pass through the filter media at least twice.

### CROSS-REFERENCE TO RELATED PATENT APPLICATIONS

This patent application claims the benefit of U.S. Provisional Patent Application No. 61/756,879, filed Jan. 25, 2013, the entire teachings and disclosure of which are incorporated herein by reference thereto.

### FIELD OF THE INVENTION

This invention generally relates to a filter media, and in particular to a fluted style of media, and method of making the same.

### BACKGROUND OF THE INVENTION

Fluid streams such as liquid flows and gaseous flows (e.g. air flows) often carry particulates that are often undesirable contaminants entrained in the fluid stream. Filters are commonly employed to remove some or all of the particulates from the fluid stream. One typical style of filter includes flutes or similar style structures through which the fluid passes. As the fluid passes through the filter media forming the flutes, the fluid is filtered and particulates are removed.

The present invention relates to improvements in filters and methods for forming filters and filter media using this flute style media.

### BRIEF SUMMARY OF THE INVENTION

Embodiments of the invention relate to filter media, filter elements and methods of forming the same where there is required multi-pass flow for the fluid. Particular embodiments relate to fluted style media and methods of forming same.

In a particular embodiment, a fluted filter media is provided. The fluted filter media includes alternating layers of face sheet portions and convoluted sheet portions. The convoluted sheet portion have a first side that faces a first side of a first face sheet portion to form a plurality of first flutes therebetween and a second side that faces a second side of a second face sheet portion to form a plurality of second flutes therebetween. This configuration is repeated for a plurality of face sheet portions and convoluted sheet portions. An inlet seal and an outlet seal are positioned within each first flute. The outlet seal is axially spaced from the inlet seal along a longitudinal axis extending between an inlet end of the fluted filter media and an outlet end of the fluted filter media. An intermediate seal is located within each second flute axially interposed between and axially spaced from the inlet and outlet seals along the longitudinal axis separating an upstream section of the second flute from a downstream section of the second flute. A downstream section of at least one of the convoluted sheet portions or the face sheet portions has a lower porosity than an upstream section of at least one of the convoluted sheet portions or the face sheet portions.

In a more particular embodiment, each of the convoluted sheet portions and the face sheet portions includes a downstream section and an upstream section, each downstream section having a lower porosity than the upstream section.

In one embodiment, the upstream and downstream sections are formed independent from one another and then subsequently secured to one another forming a seam between the upstream and downstream sections. In a more particular embodiment, the upstream and downstream sections are welded to one another at the seam.

In one embodiment, the intermediate seal overlaps the seam between the upstream and downstream sections.

In one embodiment, the first flutes form a mid-channel section between the inlet and outlet seals wherein fluid must pass through one of the convoluted sheet portion or face sheet portion to enter the mid-channel section and must pass through one of the convoluted sheet portion or face sheet portion to exit the mid-channel section. In a more particular implementation, as fluid to be filtered flows from the inlet end of the fluted filter media to an outlet end of the fluted filter media in a downstream direction, the fluid enters the inlet section of the second flutes, exits the inlet section through one of the convoluted sheet portion and the face sheet portion into the mid-channel section, exits the mid-channel section through one of the convoluted sheet portion and the face sheet portion into the outlet section, and exits the media through the outlet section.

In one embodiment, the sheet portions that include the downstream section of lower porosity include a substrate layer and at least one coating layer. The at least one coating layer reduces the porosity of the downstream section relative to the upstream section thereof. The upstream section thereof is provided, at least in part, by the substrate layer.

In one embodiment, the substrate layer is provided by a melt blown media and the coating layer is provided by an electro-spun media.

In one embodiment, the downstream section is provided by an entanglement of fine fibers.

In one embodiment, a porosity difference between the upstream and downstream sections is not provided by mechanically deforming the upstream section to increase the porosity thereof, such as by puncturing or piercing the media.

In one embodiment, the downstream section has a filter media substrate layer and a high-efficiency fine fiber layer.

In one embodiment, the upstream section is provided by the substrate layer of the downstream portion.

In one embodiment, the upstream and downstream portions have a shared filter media substrate layer. The upstream section has a first high efficiency layer and the downstream section has a second high efficiency layer. The second high efficiency layer provides the lower porosity.

In one embodiment, the first high efficiency layer and second high efficiency layer are provided by a same type of high efficiency media having a first section forming part of the upstream section and a second section forming part of the downstream section. The first section is different than the second section to provide the lower porosity for the second portion.

In one embodiment, the layer of high efficiency media is deposited onto the shared filter media substrate layer and the first section is deposited at a different rate than the second section.

In one embodiment, the shared filter media substrate layer is a melt-blow fiber filter media layer and the first high efficiency layer and the second high efficiency layer are provided by an electro-spun nano-fiber media layer. The first and second sections of the electro-spun nano-fiber media layer have different filtering characteristics.

In one embodiment, the substrate layer forms the first side of the corresponding sheet portion and the high-efficiency fine fiber layer forms, at least part of, the second side of the sheet portion.

In one embodiment, the substrate layer forms the second side of the sheet portion and the high-efficiency fine fiber layer forms, at least part of, the first side of the sheet portion.

In one embodiment, the inlet seal has a thickness that is generally perpendicular to the flutes that is greater than a thickness of the outlet seal.

A method of forming a fluted media pack is also provided. The method includes alternating layering layers of face sheet portions and convoluted sheet portions, each convoluted sheet portion has a first side that faces a first side of a first face sheet portion to form a plurality of first flutes therebetween and a second side that faces a second side of a second face sheet portion to form a plurality of second flutes therebetween; forming an inlet seal within each of first flute proximate an inlet end of first flute; forming an outlet seal within each of first flute proximate an outlet end of the first flute, the outlet seal being axially spaced from the inlet seal along a longitudinal axis extending between an inlet end of the fluted filter media and an outlet end of the fluted filter media; forming an intermediate seal within each second flute axially interposed between and axially spaced from the inlet and outlet seals along the longitudinal axis separating an upstream section of the second flute from a downstream section of the second flute; and wherein a downstream section of at least one of the convoluted sheet portions or the face sheet portions has a lower porosity than an upstream section of at least one of the convoluted sheet portions or the face sheet portions.

In one method, each of the convoluted sheet portions and the face sheet portions includes a downstream section and an upstream section, each downstream section having a lower porosity than the upstream section.

In one method, the method further comprises: forming the convoluted sheet portions by securing the downstream section of the convoluted sheet portions with the upstream section of the convoluted sheet portions forming a seam therebetween; and forming the face sheet portions by securing the downstream portion of the face sheet portions with the upstream portion of the face sheet portion forming a seam therebetween.

In one method, forming the convoluted sheet portions includes welding the upstream section of the convoluted sheet portions to the downstream section of the convoluted sheet portions; and forming the face sheet portions includes welding the upstream section of the face sheet portions to the downstream section of the face sheet portions.

In one method, forming the intermediate seal includes overlapping the seams with the intermediate seal.

In one method, the method further comprises forming the face sheet portions; and forming the convoluted sheet portions. In a more particular method, forming the face sheet portions includes: providing a substrate layer that provides at least part of the upstream and downstream sections of the face sheet portions; coating at least a portion of the substrate layer to define the downstream section of the face sheet portions; and forming the convoluted sheet portions includes: providing a substrate layer that provides at least part of the upstream and downstream sections of the convoluted sheet; and coating at least a portion of the substrate layer to define the downstream section of the face sheet portions.

In one method, the substrate layers includes melt blowing to form the substrate layer and coating the substrate layer includes electro-spinning fine fibers onto the substrate layer.

In one method, forming the face sheet portions includes: providing a substrate layer that provides at least part of the upstream and downstream sections of the face sheet portions; coating the substrate layer with a first portion of coating to define the downstream section of the face sheet portions; coating the substrate layer with a second portion of coating to define the upstream section of the face sheet portions, the second portion of coating providing the upstream section with a higher porosity than the downstream section; and forming the convoluted sheet portions includes: providing a substrate layer that provides at least part of the upstream and downstream sections of the convoluted sheet portions; coating the substrate layer with a first portion of coating to define the downstream section of the convoluted sheet portions; coating the substrate layer with a second portion of coating to define the upstream section of the convoluted sheet portions, the second portion of coating providing the upstream section with a higher porosity than the downstream section.

In one method, the substrate layer is provided by a melt blown process and the coating layers are provided by an electro-spinning process.

In one method, the electro-spinning process for the upstream sections is modified as compared to the electro spinning process for the downstream sections.

In one method, the modification between the electro spinning processes can be any one of: 1) varying the voltage for the different sections; 2) varying the type of material that is electro spun; 3) varying the vacuum applied during the electro spinning process to the different sections; 4) varying the configuration of the electro-spinning apparatus, such as varying the size, shape or number electro-spinning locations; and 5) varying the size of the electrodes for the electro-spinning apparatus between the different sections.

One method, excludes mechanically deforming the upstream section to increase the porosity thereof.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIGS. 1 and 8 are simplified partial illustrations of fluted filter media according to an embodiment of the present invention;

FIG. 2 is a simplified cross-sectional illustration of the fluted filter media of FIG. 1 taken through the inlet seal;

FIG. 3 is a simplified cross-sectional illustration of the fluted filter media of FIG. 1 taken through the intermediate seal;

FIG. 4 is a schematic illustration of an embodiment of a system for forming the filter media according to FIG. 1;

FIG. 5 is a schematic illustration of an alternative embodiment of a system for forming the filter media according to FIG. 1;

FIG. 6 is an end view of the filter media being formed using the system of FIG. 5; and

FIG. 7 is a partial exploded illustration of the filter media of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

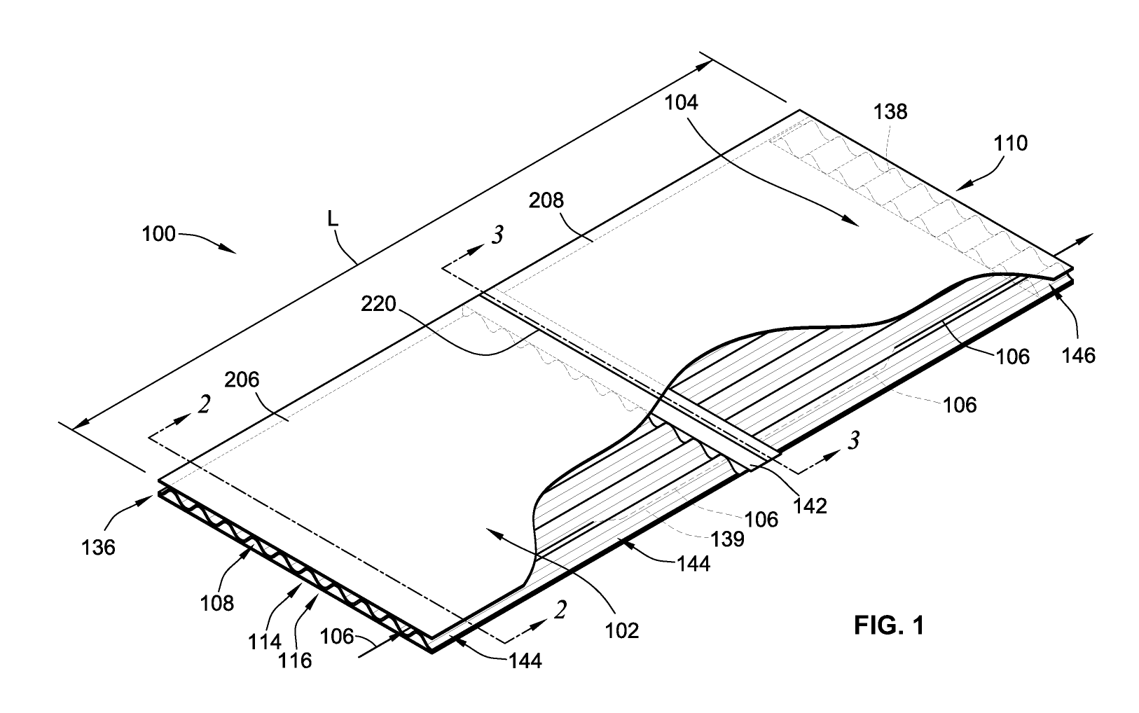

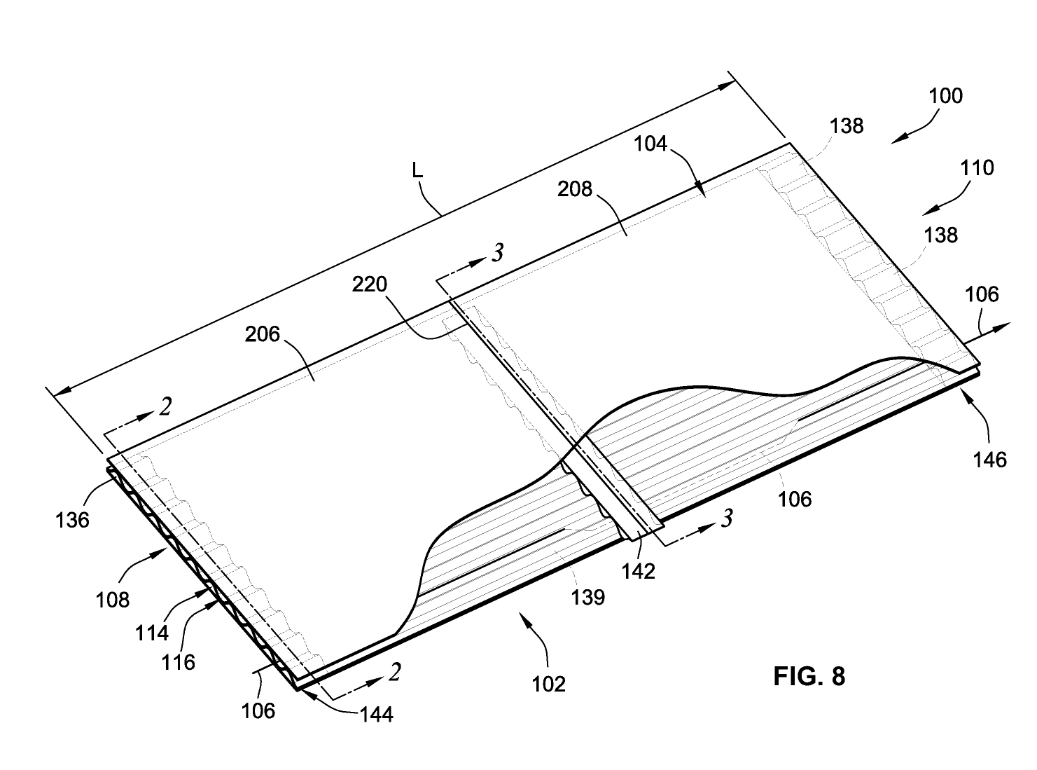

FIGS. 1 and 8 illustrate a portion of fluted filter media 100 formed in accordance with embodiments of the present invention. The fluted filter media 100 includes a low efficiency and/or high capacity section 102 (also referred to as “high porosity section 102”) that is generally upstream from a high efficiency and/or low capacity section 104 (also referred to as “low porosity section 104”). While the difference between the two sections 102, 104 of the filter media 100 is typically provided by different porosities, other embodiments may use different types of materials such as nylons or other polymers, different types of depth loading, different types of coatings, activating agents or electrical charges to vary the efficiency and capacity of the different sections of the filter media 100.

Fluid to be filtered (illustrated by arrows 106) will enter the filter media 100 at inlet end face 108 and exit the filter media 100 at outlet end face 110. The high porosity section 102 will typically be upstream from the low porosity section 104 and therefore be closer to and/or form the inlet end face 108. Likewise, the low porosity section 104 will typically be closer to and/or form the outlet end face 110.

The illustrated fluted filter media 100 is in the form of a fluted style media that includes a plurality of channels or flutes through which the fluid 106 passes as it travels from the inlet face 108 to the outlet face. While the term “flute” is used herein, flute shall be broadly construed to include all types of similar media such as z-media, gathered media, corrugated media, media with tapered flute sidewalls, etc.

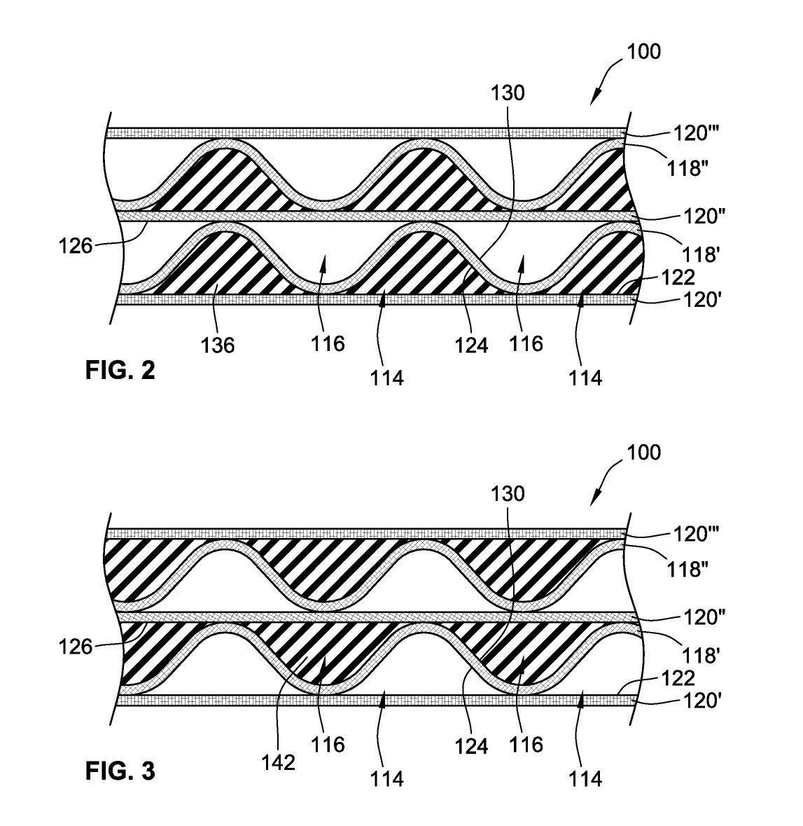

With additional reference to FIG. 2, the fluted filter media 100 includes a plurality of alternating layers of convoluted sheet portions 118 and face sheet portions 120 that form a plurality of first flutes 114 and a plurality of second flutes 116. The first and second flutes 114, 116 are generally separated from one another by the convoluted sheet portions 118. The plurality of first flutes 114 are formed between a first side 122 of the face sheet portions 120 and a first side 124 of the convoluted sheet portions 118. The plurality of second flutes 116 are formed between a second side 126 of the face sheet portions 120 and a second side 130 of the convoluted sheet portions 118. As such, the convoluted sheet portions 118 separates the first and second flutes 114, 116 from one another.

Typically, the fluted filter media 100 will be employed in a filter media pack that includes a plurality of alternating face sheet portions 120 and convoluted sheet portions 118. This can be done by providing a convoluted sheet portion 118 attached to a face sheet portion 120 and winding the combination around an axis of rotation that is generally parallel to the flutes 114, 116, i.e. parallel to a longitudinal axis that extends perpendicular relative to the inlet end face 108 and outlet end face 110. Alternatively, a plurality of sections of a convoluted sheet 118 secured to a single face sheet portions 120 will be stacked on top of one another. However, in each configuration, each convoluted sheet 118 is positioned between two face sheet portions 120, such as convoluted sheet 118′ and face sheet portions 120′, 120″.

With reference to FIGS. 1, 7 and 8, the fluted filter media 100 is configured to cause the filtered fluid 106 to pass through the filter media thereof at least twice. To do this, the plurality of first flutes 114 are configured as closed flutes that have an inlet seal 136 and an outlet seal 138. More particularly, both the inlet seal 136 and outlet seal 138 are formed between first side 122 of the face sheet portions 120 and the first side 124 of the convoluted sheet portions 118. The inlet seal 136 is positioned axially proximate the inlet end face 108 while the outlet seal 138 is positioned axially proximate the outlet end face 110, along the longitudinal axis defined by the flutes 114, 116 and between end faces 108, 110. The first plurality of flutes 114 form completely closed mid channel sections 139 that are only accessible and able to be exited by a filtered fluid 106 if the fluid passes through either the face sheet portions 120 or the convoluted sheet portions 118.

An intermediate seal 142 separates the plurality of second flutes 116 into an upstream inlet section 144 and a downstream outlet section 146. The intermediate seal 142 is positioned axially along the longitudinal axis extending between the inlet end face 108 and outlet end face 110 between the inlet and outlet seals 136, 138. With reference to FIG. 3, the intermediate seal 142 is positioned between the second side 130 of the convoluted sheet portions 118 (i.e. opposite the first side 124) and the second side 126 of the face sheet portions 120.

Fluid 106 will enter into the inlet section 144 of the plurality of second flutes 116. Because the intermediate seal 142 plugs the plurality of second flutes 116 upstream of the outlet end face 110, the fluid 106 is forced to pass through either the convoluted sheets 118 or the face sheet portions 120. Once in the mid-channel section 139 formed by the plurality of first flutes 114, which are closed at both ends by the inlet and outlet seals 136, 138, the fluid is trapped within the mid-channel section 139. The fluid is thus forced to pass back through either the convoluted sheet portions 118 or the face sheet portions 120 to exit the mid-channel section 139 into the outlet section 146 of the plurality of second flutes 116 to exit the fluted filter media 100. As such, it can be seen that the filter fluid 106 must pass through filter media twice as it flows through fluted filter media 100.

Preferably, the upstream section 102 of the fluted filter media 100 is configured to have low efficiency and/or high capacity and the downstream section 104 is configured to have high efficiency and/or low capacity. This allows large particles to be trapped and filtered from the fluid 106 by the upstream section 102 and smaller particles to be trapped and filtered from the fluid 106 by the downstream section 104. More particularly, the larger particles are trapped during the first pass through filter media and particular as the fluid travels from the inlet sections 144 of the plurality of second flutes 116 to the mid-channel section 139 of the plurality of first flutes 114. Due to the larger porosity of the upstream section 102, smaller particles may pass into the mid-channel section 139 of the first flutes 114. However, as the fluid 106 passes from the mid-channel section 139 of the first flutes 114 into the outlet section 146 of the plurality of second flutes 116, the lower porosity thereof will trap the smaller particles.

This configuration of the two different types of filtering aligned inline allows for maximizing the filtering capacity for a given length L between the inlet end face 108 and outlet end face 110. It is contemplated that by using the multi-step filtering provided by this arrangement, a shorter overall filter element can be used but provide the same filtering capacity as compared to other filters.

In some embodiments, the upstream and downstream sections 102, 104 may be formed independently and then secured to one another at a seam 220. This seam may be formed by ultrasonic welding of the two sections 102, 104 together. Alternatively, an adhesive may be used to secure the two sections 102, 104 together.

In alternative embodiments, the convoluted sheet portions 118 and face sheet portions 120 could be formed to have an upstream section and a downstream section prior to being secure together to form the flutes 114, 116 and prior to being corrugating/fluting of the convoluted sheet portions 118.

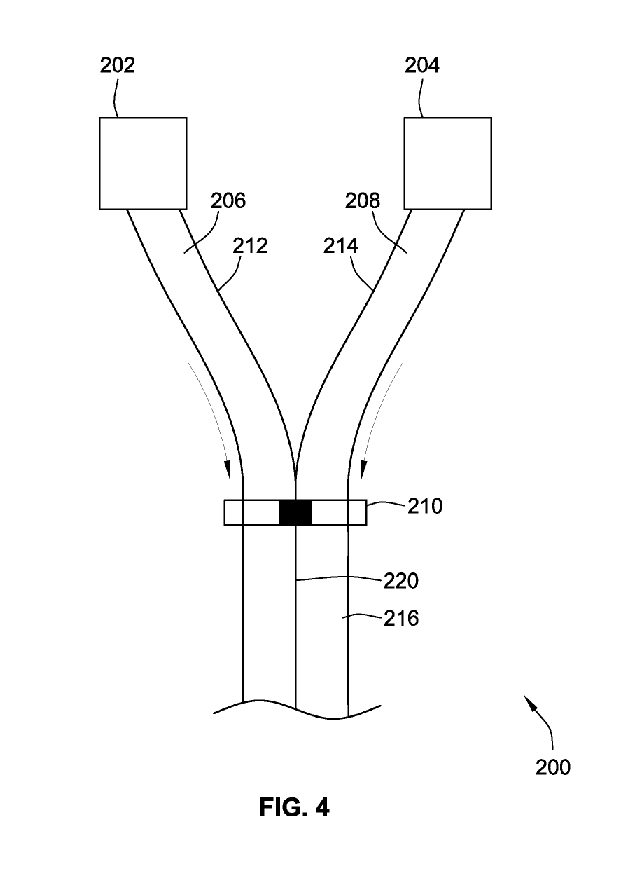

FIG. 4 is a schematic illustration of one system 200 for forming the filter media that can subsequently be used for the convoluted sheet portions 118 and face sheet portions 120. Here, there are two filter media sources 202, 204. The first filter media source 202 supplies a first web of filter media 206, typically as a flat web of filter media. The second filter media source 204 supplies a second web of filter media 208, typically as a flat web of filter media. The second web of filter media 208 has a different characteristic than the first web of filter media 206. In one embodiment, the first web of filter media 206 has a higher porosity than the second web of filter media 208.

The two webs of filter media 206, 208 are fed to a joining station 210. Adjacent free edges 212, 214 of the webs of filter media 206, 208 are joined together at the joining station 210 to secure the two webs of filter media 206, 208 to one another. In one embodiment, the joining station 210 ultrasonically welds the adjacent free edges 212, 214 together to secure the two webs of filter media 206, 208 to one another to form a hybrid web of filter media 216 that has non-homogenous characteristics separated by seam 220 securing the two webs of filter media 206, 208 together. In some embodiments, the joining station 210 uses adhesives or chemical reactions to secure the two webs of filter media 206, 208 together. During the joining process, the two webs of filter media 206, 208 could be slightly overlapped to provide improved joining

This hybrid web of filter media 216 can then be used to form one or both of the convoluted sheet portions 118 and face sheet portions 120 of the fluted filter media 100 described above. Preferably, when forming the fluted filter media 100, the inlet and outlet seals 136, 138 are formed first to best hold the convoluted sheet portions 118 to the face sheet portions 120. Then, as the combination of the face sheet portion 120 and convoluted sheet portion 118 with the inlet and outlet seals 136, 138 is wound or stacked the intermediate seal 142 is placed between the different stacks or layers of the combined convoluted sheet portion 118, face sheet portion 120 and inlet and outlet seals 136, 138.

With reference to FIGS. 1 and 8, it is preferred that the intermediate seal 142 is located at and covers any seam 220 between the two webs of filter media 206, 208 so as to further reduce the risk of any leakage through the seam 220. In FIG. 1, the first web of filter media 206 that has a higher porosity is used to form the upstream section 102 while the second web of filter media 208 that has the lower porosity is used to form the downstream section 104 of fluted filter media 100.

The hybrid web of filter media 216 can be a combination of various different types of media. For instance, the hybrid web of filter media 216 could be formed using any one or combination of the methods of forming filter media described in U.S. patent application Ser. No. 11/942,937 filed Nov. 20, 2007 and now granted as U.S. Pat. No. 7,967,588 on Jun. 28, 2011; U.S. patent application Ser. No. 11/942,949 filed Nov. 20, 2007 and now granted as U.S. Pat. No. 7,815,427; U.S. patent application Ser. No. 61/081,883 filed Jul. 18, 2008; U.S. patent application Ser. No. 61/090,259 filed Aug. 20, 2008; U.S. patent application Ser. No. 12/428,232 filed Apr. 22, 2009 and now published as U.S. Pat. Appln. Publication No. 2009-0266759-A1 on Oct. 29, 2009; U.S. patent application Ser. No. 12/357,499 filed Jan. 22, 2009 and now granted as U.S. Pat. No. 8,172,092 on May 8, 2012; U.S. patent application Ser. No. 13/032,227 filed Feb. 22, 2011 and now published as U.S. Pat. Appln. Publication No. 2011-0210060-A1 on Sep. 1, 2011; and U.S. patent application Ser. No. 13/032,327 filed Feb. 22, 2011 and now published as U.S. Pat. Appln. Publication No. 2011-0210061-A1 on Sep. 1, 2011. Additionally, the individual or combined webs of filter media could be formed in accord with International Application PCT/US2009/050392 filed Jul. 13, 2009, the teachings and disclosure of all of these applications is incorporated herein by reference thereto. These applications relate to electro-spinning of fine fibers, melt blown medias, nano-matrix medias, nano-fiber media, multi-component media and entangled webs of fine fibers, among other types of medias.

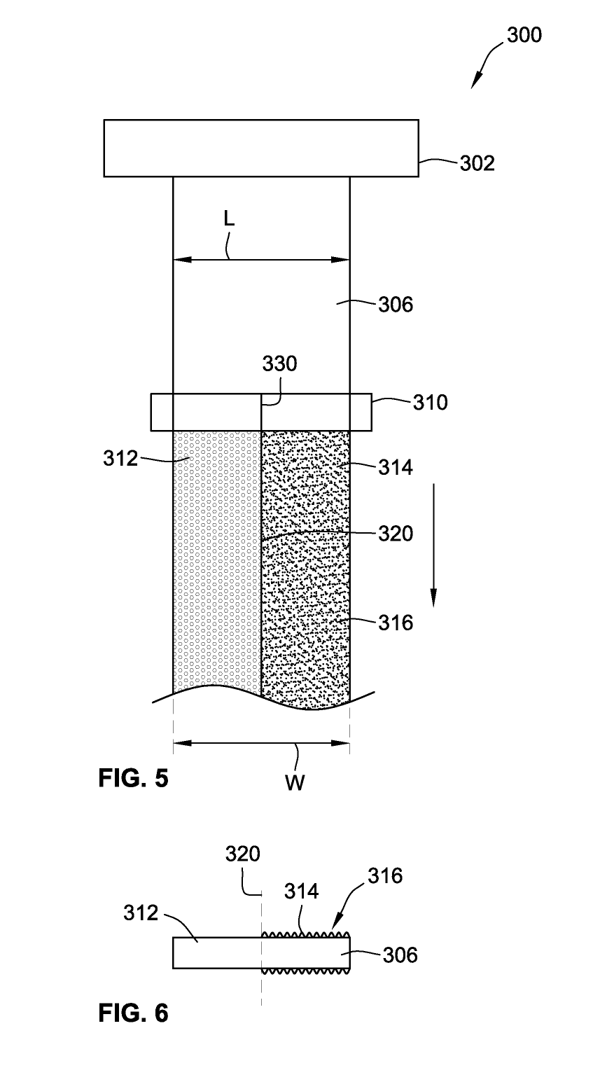

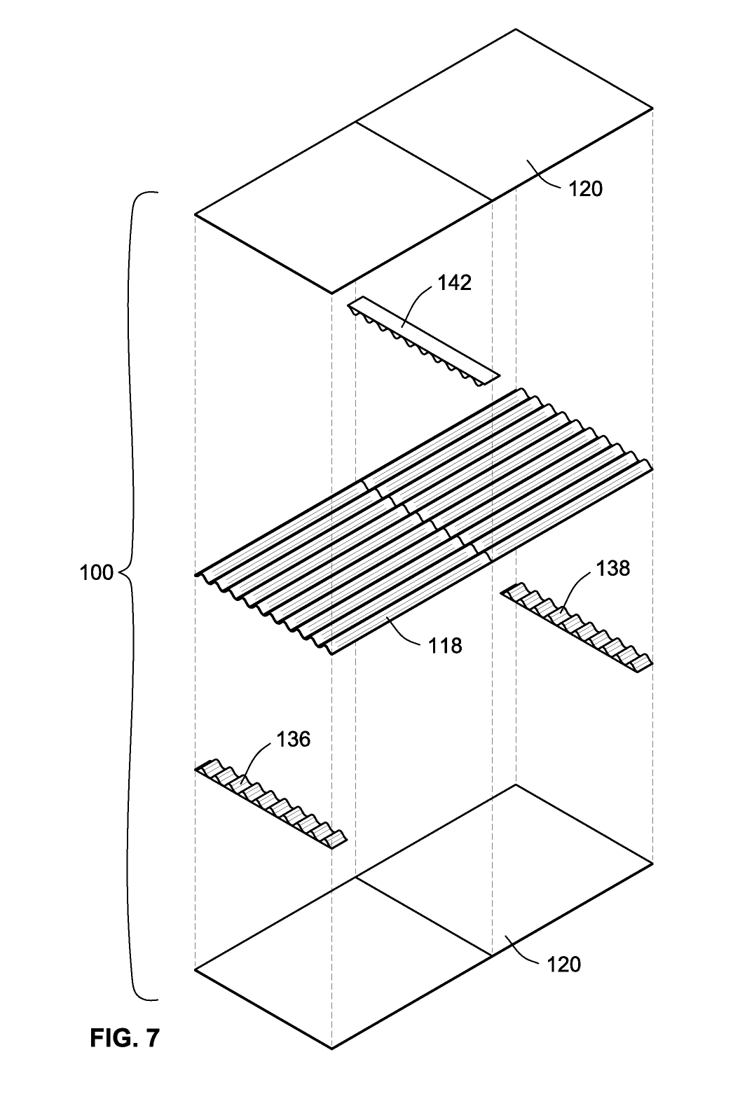

FIGS. 5 and 6 illustrate, in simplified form, additional ways that he hybrid web of filter media could be formed. In FIG. 5, a system 300 for forming another hybrid web of filter media 316 is provided. In this embodiment, a single substrate layer 306 is supplied by a source 302 of filter media. The single substrate layer 306 is fed to a modifying station 310 where the single substrate layer 306 is transformed into a single web of material that has two sections 312, 314 that have different filtering characteristics, such as efficiency, porosity, or capacity. In this embodiment, each section 312, 314 provides about half of the width W of the hybrid web of filter media 316. The first section 312 will provide the filter media for the upstream section 102 of fluted filter media 100. The second section 314 will provide the downstream section 104 of fluted filter media 100.

In some embodiments, the first section 312 could be unmodified and be substantially identical to the upstream substrate layer 306. The second section 314 will typically be modified from its state upstream of the modifying station 310. In some embodiments, a coating could be provided to the second section 314 while the first section 312 remains in substantially the same state downstream from the modifying station 310 as it was upstream of the modifying station 310. A divider or shield 330 could be provided in the modifying station 310 to attempt to better separate the operations that occur on the second section 314 from the first section 312. However, in alternate embodiments, the first section 312 could be modified while the second section 314 could remain unmodified.

In another embodiment, both the first and second sections 312, 314 could be manipulated/modified by the modifying station 310. They could be modified in the same way but to different degrees. For instance, if a coating is applied by the modifying station 310 that reduces porosity, more of the coating could be applied to the second section 314 than to the first section 312 so as to provide an overall difference between the two sections 312, 314 when the hybrid web of filter media 316 is formed.

In some embodiments, the single substrate layer 306 could be a melt-blown filter media and the modifying station could electro-spin nano-fibers onto the substrate layer 306 on one or both of the sections 312, 314. If both sections 312, 314 receive nano-fibers, the modifying station 310 could be configured such that more or less, different size, different composition, etc. nano fibers are applied to one section 312, 314 to provide the difference characteristics between the different sections 312, 314. This could be done by modifying the voltage, electro-spinning sites, the composition of the fluid, temperature, or the vacuum that are applied to the different sections 312, 314.

Because the separate sections 312, 314 of filter media may have different thicknesses, see e.g. FIG. 6, the inlet and outlet seals 136, 138 may have to have different thicknesses so as to compensate and prevent the filter media 100 from taking odd/non-uniform shapes.

It is noted that the above identified filter media avoids mechanically deforming the web of filter media to provide the different porosities/capacities/efficiencies. As such, medias and methods according to some embodiments do not include any mechanical piercing of any of the filter media.

While the illustrated embodiments only require the filtered fluid to travel through the filter media twice, other embodiments could utilize more than one intermediate seal and could cause the fluid to make more than two passes through the filter media. Further, more than two sections of filter media could be provided with multiple filtering properties.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A fluted filter media comprising:
alternating layers of face sheet portions and convoluted sheet portions, each convoluted sheet portion has a first side that faces a first side of a first adjacent face sheet portion to form a plurality of first flutes therebetween and a second side that faces a second side of a second adjacent face sheet portion to form a plurality of second flutes therebetween;
an inlet seal within the first flutes proximate an inlet end of the first flutes;
an outlet seal within the first flutes proximate an outlet end of the first flutes, the outlet seal being axially spaced from the inlet seal along a longitudinal axis extending between an inlet end face of the fluted filter media and an outlet end face of the fluted filter media;
an intermediate seal within the second flutes axially interposed between and axially spaced from the inlet and outlet seals along the longitudinal axis, the intermediate seal separating an inlet section of the second flutes from an outlet section of the second flutes; and
wherein a downstream section of at least one of the convoluted sheet portions or the face sheet portions has a lower porosity than an upstream section of at least one of the convoluted sheet portions or the face sheet portions.

2. The fluted filter media of claim 1, wherein each of the convoluted sheet portions and the face sheet portions includes a downstream section and an upstream section, each downstream section having a lower porosity than the upstream section.

3. The fluted filter media of claim 2, wherein the upstream and downstream sections are formed independent from one another and then subsequently secured to one another forming a seam between the upstream and downstream sections.

4. The fluted filter media of claim 3, wherein the upstream and downstream sections are welded to one another at the seam.

5. The fluted filter media of claim 3, wherein the intermediate seal overlaps the seam between the upstream and downstream portions.

6. The fluted filter media of claim 1, wherein the first flutes form a mid-channel section between the inlet and outlet seals wherein fluid must pass through one of the convoluted sheet portion or face sheet portion to enter the mid-channel section and must pass through one of the convoluted sheet portion or face sheet portion to exit the mid-channel section.

7. The fluted filter media of claim 6, wherein:
wherein, as fluid to be filtered flows from the inlet end of the fluted filter media to an outlet end of the fluted filter media in a downstream direction, the fluid enters the inlet section of the second flutes, exits the inlet section through one of the convoluted sheet portion and the face sheet portion into the mid-channel section, exits the mid-channel section through one of the convoluted sheet portion and the face sheet portion into the outlet section, and exits the media through the outlet section.

8. The fluted filter media of claim 1, wherein the sheet portions that include the downstream section of lower porosity includes a substrate layer and at least one coating layer, the at least one coating layer reducing the porosity of the downstream section relative to the upstream section thereof, the upstream section thereof being provided by the substrate layer.

9. The fluted filter media of claim 8, wherein the substrate layer is provided by a melt blown media and the coating layer is provided by an electro-spun media.

10. The fluted filter media of claim 1, wherein the downstream section is provided by an entanglement of fine fibers.

11. The fluted filter media of claim 1, wherein a porosity difference between the upstream and downstream sections is not provided by mechanically deforming the upstream section to increase the porosity thereof.

12. The fluted filter media of claim 1, wherein the downstream section has a filter media substrate layer and a high-efficiency fine fiber layer.

13. The fluted filter media of claim 12, wherein the upstream section is provided by the substrate layer of the downstream portion.

14. The fluted filter media of claim 1, wherein the upstream and downstream portions have a shared filter media substrate layer, and wherein the upstream section has a first high efficiency layer and the downstream section has a second high efficiency layer, the second high efficiency layer providing the lower porosity.

15. The fluted filter media of claim 14, wherein the first high efficiency layer and second high efficiency layer are provided by a same type of high efficiency media having a first section forming part of the upstream section and a second section forming part of the downstream section, the first section being different than the second section to provide the lower porosity for the second portion.

16. The fluted filter media of claim 15, wherein the layer of high efficiency media is deposited onto the shared filter media substrate layer and wherein the first section is deposited at a different rate than the second section.

17. The fluted filter media of claim 14, wherein the shared filter media substrate layer is a melt-blow fiber filter media layer and the first high efficiency layer and the second high efficiency layer are provided by an electro-spun nano-fiber media layer, wherein the first and second sections of the electro-spun nano-fiber media layer have different filtering characteristics.

18. The fluted filter media of claim 13, wherein the substrate layer forms the first side of the sheet portion and the high-efficiency fine fiber layer forms, at least part of, the second side of the sheet portion.

19. The fluted filter media of claim 13, wherein the substrate layer forms the second side of the sheet portion and the high-efficiency fine fiber layer forms, at least part of, the first side of the sheet portion.

20. The fluted filter media of claim 1, wherein the inlet seal has a thickness that is generally perpendicular to the flutes that is greater than a thickness of the outlet seal.

21. A method of forming a fluted media pack comprising:
alternating layering layers of face sheet portions and convoluted sheet portions, each convoluted sheet portion has a first side that faces a first side of a first face sheet portion to form a plurality of first flutes therebetween and a second side that faces a second side of a second face sheet portion to form a plurality of second flutes therebetween;
forming an inlet seal within each of first flute proximate an inlet end of first flute;
forming an outlet seal within each of first flute proximate an outlet end of the first flute, the outlet seal being axially spaced from the inlet seal along a longitudinal axis extending between an inlet end of the fluted filter media and an outlet end of the fluted filter media;
forming an intermediate seal within each second flute axially interposed between and axially spaced from the inlet and outlet seals along the longitudinal axis separating an upstream section of the second flute from a downstream section of the second flute; and
wherein a downstream section of at least one of the convoluted sheet portions or the face sheet portions has a lower porosity than an upstream section of at least one of the convoluted sheet portions or the face sheet portions.

22. The method of claim 21, wherein each of the convoluted sheet portions and the face sheet portions includes a downstream section and an upstream section, each downstream section having a lower porosity than the upstream section.

23. The method of claim 22, further comprising:
forming the convoluted sheet portions by securing the downstream section of the convoluted sheet portions with the upstream section of the convoluted sheet portions forming a seam therebetween;
forming the face sheet portions by securing the downstream portion of the face sheet portions with the upstream portion of the face sheet portion forming a seam therebetween.

24. The method of claim 23, wherein:
forming the convoluted sheet portions includes welding the upstream section of the convoluted sheet portions to the downstream section of the convoluted sheet portions; and
forming the face sheet portions includes welding the upstream section of the face sheet portions to the downstream section of the face sheet portions.

25. The method of claim 23, wherein forming the intermediate seal includes overlapping the seams with the intermediate seal.

26. The method of claim 21, further comprising:
forming the face sheet portions; and
forming the convoluted sheet portions.

27. The method of claim 26, wherein forming the face sheet portions includes:
providing a substrate layer that provides at least part of the upstream and downstream sections of the face sheet portions;
coating at least a portion of the substrate layer to define the downstream section of the face sheet portions;
wherein forming the convoluted sheet portions includes:
providing a substrate layer that provides at least part of the upstream and downstream sections of the convoluted sheet;
coating at least a portion of the substrate layer to define the downstream section of the face sheet portions.

28. The method of claim 27, wherein the substrate layers includes melt blowing to form the substrate layer and coating the substrate layer includes electro spinning fine fibers onto the substrate layer.

29. The method of claim 26, wherein forming the face sheet portions includes:
providing a substrate layer that provides at least part of the upstream and downstream sections of the face sheet portions;
coating the substrate layer with a first portion of coating to define the downstream section of the face sheet portions;
coating the substrate layer with a second portion of coating to define the upstream section of the face sheet portions, the second portion of coating providing the upstream section with a higher porosity than the downstream section;
wherein forming the convoluted sheet portions includes:
providing a substrate layer that provides at least part of the upstream and downstream sections of the convoluted sheet portions;
coating the substrate layer with a first portion of coating to define the downstream section of the convoluted sheet portions;
coating the substrate layer with a second portion of coating to define the upstream section of the convoluted sheet portions, the second portion of coating providing the upstream section with a higher porosity than the downstream section.

30. The method of claim 29, wherein the substrate layer is provided by a melt blown process and the coating layers are provided by an electro-spinning process.

31. The method of claim 30, wherein the electro spinning process for the upstream sections is modified as compared to the electro spinning process for the downstream sections.

32. The method of claim 31, wherein the modification between the electro spinning processes can be any one of:
1) varying the voltage for the different sections;
2) varying the type of material that is electro spun;
3) varying the vacuum applied during the electro spinning process to the different sections;
4) varying the configuration of the electro-spinning apparatus, such as varying the size, shape or number electro-spinning locations; and
5) varying the size of the electrodes for the electro-spinning apparatus between the different sections.

33. The method of claim 21, excluding mechanically deforming the upstream section to increase the porosity thereof.
